(19) United States
(12) Patent Application Publication
(10) Pub. No.: US 2006/0190405 A1
(43) Pub. Date: Aug. 24, 2006

(54) Utilizing distribution types to assign attributes to distribution lines in an accounting system

(75) Inventors: Kristi M. Weekley, Lake Park, MN (US); Ronald H. Schulz, W. Fargo, ND (US); Steven T. Degele, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/063,197

(22) Filed: Feb. 22, 2005

(51) Int. Cl. G06F 17/60

(52) U.S. Cl. 705/52

(57) ABSTRACT

A computer-implemented financial system that includes a user interface for entering transaction header data, which includes a transaction header amount. The financial system also includes a distribution type component that associates the transaction header amount with at least one distribution type (named category with associated characteristics) of multiple distribution types. The distribution type component also utilizes the at least one distribution type associated with the transaction header amount to build at least one transaction distribution line corresponding to the transaction header amount. Additionally, the distribution type component links the at least one distribution type with the at least one distribution line. The linked at least one distribution type dictates what actions can be performed on the at least one distribution line.

### BACKGROUND OF THE INVENTION

The present invention generally relates to computerized financial/accounting systems. More particularly, the present invention relates to utilizing distribution types to assign attributes to distribution lines in a financial/accounting system.

Computerized financial systems and programs (i.e., software applications) are configured for use by both accountants and non-accountants. These systems allow users to set up various types of modules such as general ledger, inventory, order entry, accounts receivable, accounts payable, bank manager, etc., and perform various tasks within each module. Additionally, such systems allow users to generate customized transaction documents that reflect paper documents that are used to create financial transactions. Such transaction documents include invoices, vendor bills, checks, deposits, journal entries and other documents that record or represent financial transactions for the business. For example, a user can generate an invoice for a transaction in which ten items are sold to a customer. The invoice lists various information about the sale, such as customer information, the date of sale, the quantity of items sold, the cost for each item, and the total cost of the sale. This information listed in an invoice is generally referred to as transaction header information. When the user saves the invoice, debit and credit entries are created for each transaction header amount and stored in the financial system. Each debit or credit entry or record is referred to as a distribution line.

Although, as mentioned above, prior art accounting systems are capable of automatically creating distribution lines when an invoice is saved, for example, the distribution lines automatically created by such systems usually only include certain “core” transaction information such as transaction date, account, dimension information, and debit (or credit) amount. The newly created distribution lines may have to be updated by a user to include unique transaction information such as product lines, quantities, or descriptions. Prior art accounting systems do not provide a relatively simple technique for assigning attributes (characteristics that allow/prevent actions, such as updates, deletes, etc., to be performed on fields of a distribution line, for example) to distribution lines.

### SUMMARY OF THE INVENTION

The present invention relates to a computer-implemented financial system that includes a user interface for entering transaction header data, which includes at least one transaction header amount. The financial system also includes a distribution type component that associates each transaction header amount with at least one distribution type (named category with associated characteristics) of multiple distribution types. The distribution type component also utilizes the at least one distribution type associated with the transaction header amount to build at least one transaction distribution line corresponding to the transaction header amount. Additionally, the distribution type component links the at least one distribution type with the at least one distribution line. The linked at least one distribution type dictates what actions can be performed on the at least one distribution line.

### BRIEF DESCRIPTION OF THE DRAWINGS

FIG. 1 is a block diagram of one illustrative computing environment in which the present invention can be implemented.

FIG. 2 is a block diagram of a financial management system utilizing distribution types in accordance with an embodiment of the present invention.

FIG. 3 is a simplified block diagram of an example invoice entry screen, which is a part of a financial system of the present invention.

FIG. 4 is a simplified block diagram illustrating an example of how distribution types are categorized and stored.

FIG. 5 is a simplified block diagram of an example business data entry screen, which is a part of the financial system of the present invention.

### DETAILED DESCRIPTION OF ILLUSTRATIVE EMBODIMENTS

The present invention relates, in general, to financial systems that are capable of automatically creating transaction distribution lines. More specifically, the present invention relates to financial systems that utilize distribution types (named categories with associated characteristics) to assign attributes to distribution lines. However, before describing the present invention in greater detail, one illustrative embodiment in which the present invention can be used will be discussed.

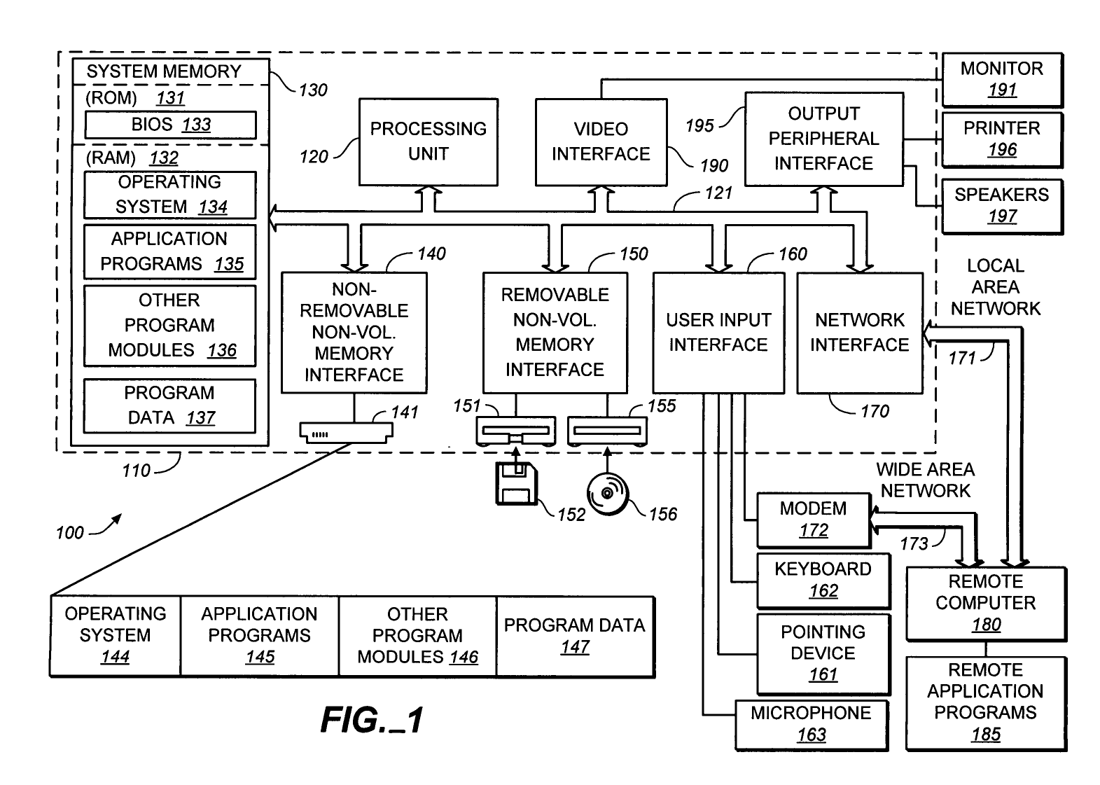

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

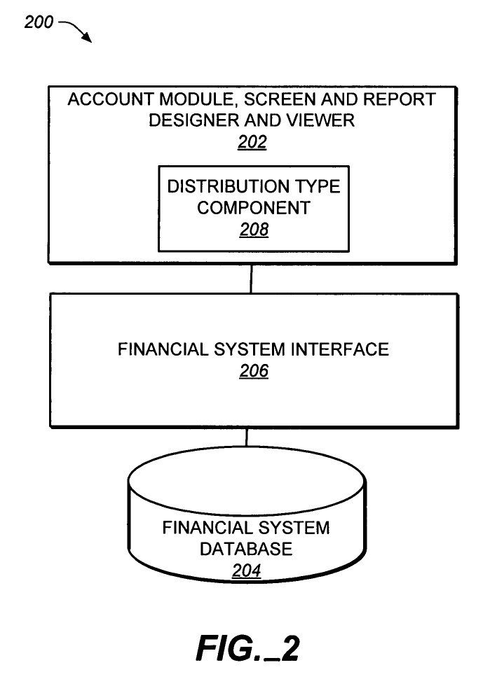

FIG. 2 is a simplified block diagram of a financial management system 200 that utilizes distribution types to assign attributes to distribution lines in accordance with an illustrative embodiment of the present invention. System 200 includes a front-end tool 202, a financial system database 204 and a financial system interface 206 between front-end tool 202 and financial system database 204.

Front-end tool 202 communicates with database 204 via interface 206. Interface 206, in general, is capable of translating generalized requests, update statements, etc., into database specific query/update statements, which typically include sequential query language (SQL) statements, that retrieve/update the necessary data stored in database 204. Interface 206 returns any data retrieved from database 204 to front-end tool 202.

Front-end tool 202 includes a number of components for designing account modules, screens and reports, and for utilizing the screens for data entry and viewing information. For simplification, only distribution type component 208 is separately shown in front-end tool 202 of FIG. 2. Distribution type component 208 includes software programs that are capable of carrying out several functions (described below), that help automatically create distribution lines in accordance with the present invention.

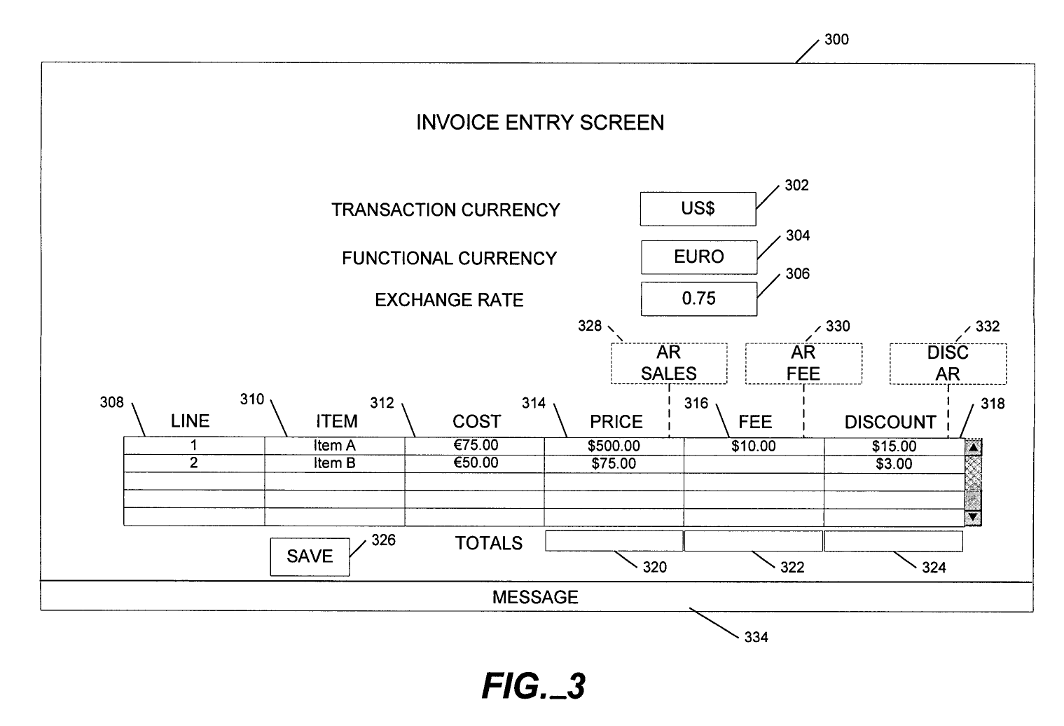

In accordance with the present invention, a user interface or screen (not shown in FIG. 2) of front-end tool 202 is used for entering transaction header data, which includes a transaction header amount, into system 200. Distribution type component 208 associates the transaction header amount with at least one distribution type of multiple distribution types. Distribution type component 208 also utilizes the at least one distribution type associated with the transaction header amount to build at least one transaction distribution line corresponding to the transaction header amount. Additionally, distribution type component 208 links the at least one distribution type with the at least one distribution line. The linked at least one distribution type dictates what actions can be performed on the at least one distribution line. An example illustrating how distribution types are utilized to build distribution lines for an example invoice is discussed below in connection with FIG. 3 and Tables 1 and 2.

FIG. 3 is a simplified block diagram of an example invoice entry screen 300, which is a part of front-end tool 202 of financial system 200 of the present invention. With the help of screen or user interface 300, a user can generate an invoice for a transaction in which items are sold to a customer, for example. In the specific example shown in FIG. 3, the invoice has two items. For simplification, only fields that are used for the specific invoice example are shown in screen 300. However, screen 300 can be designed to include any suitable number of fields.

In FIG. 3, a first portion of invoice entry screen 300 includes a transaction currency field 302, a functional currency field 304 and an exchange rate field 306. A second portion of invoice entry screen 300, which is utilized to enter transaction lines, includes a line number field/column 308, an invoice item field/column 310, a cost field/column 312, a price field/column 314, a fee field/column 316 and a discount field/column 318. Totals for different columns are included in fields 320-324. A message field 334 to display errors and other messages is also included.

Distribution types, which are transparent to a user entering transaction information into screen 300, are assigned to price field 314, fee field 316 and discount field 318 at the time screen 300 is created, for example. Four different distribution types, each linked (with the help of software functions within distribution type component 208, for example) to at least one of fields 314, 316 and 318 are listed, along with their associated characteristics, in Table 1 further below. It should be noted that, in general, all distribution types and their corresponding characteristics are stored in database 204. Software applications, internal or external to the financial system, can be granted access to add distribution types to database 204. In an example embodiment, the financial system can initially include a “predefined” list of distribution types. ISVs (Independent Software Vendors) can add their own distribution types to what is stored in database 204. For example, an ISV may add a new amount field to the transaction header and need distribution lines to be created for this amount field. The financial system allows the ISV to create a new distribution type and “link” it to the amount field.

As mentioned above, four different distribution types, each linked to at least one of fields 314, 316 and 318 are listed, along with their associated characteristics, in Table 1 below:

TABLE 1

| | | | Split DL | | |
|---|---|---|---|---|---|
| | Change | Change | into more | Change | |
| | Account/ | Amount | than one | currency | Delete |
| DT | Dimensions | in DL | line | info | DL |
| AR | YES | NO | YES | NO | NO |
| Sales | YES | NO | NO | NO | NO |
| Fee | YES | NO | YES | NO | NO |
| Disc | YES | NO | NO | YES | NO |

In Table 1 above, DT refers to distribution type, DL refers to distribution line, Disc refers to discount, info refers to information and AR refers to accounts receivable. Characteristics of the distribution types (columns to the right of the DT column in the above Table 1) have been assigned “YES” or “NO” values in the above manner only to illustrate certain actions (such as allowing/preventing deletion of distribution lines, allowing/preventing splitting of distribution lines, etc.) that each distribution type can dictate. In general, values for characteristics such as those included in Table 1 above can be assigned in any suitable manner.

In a specific embodiment of screen 300, price column/field 314 is assigned AR and sales distribution types 328, fee column/field 316 is assigned AR and fee distribution types 330 and discount column/field 318 is assigned discount and AR distribution types 332. When a user saves the invoice information shown in FIG. 3 (by pointing and clicking on save button 326, using a mouse, for example), distribution lines for transaction lines 1 and 2 are created with the help of the assigned distribution types and stored in database 204. In some embodiments, the distribution lines are created before saving the invoice. These distribution lines are persisted or committed to the database when the save is complete. Table 2 below shows the distribution lines created for line 1 (the first transaction line) of the example shown in FIG. 3.

TABLE 2

| | | | | Exch | Func | Func | |
|---|---|---|---|---|---|---|---|
| Account | Dept | Trx DR | Trx CR | Rate | DR | CR | DT |
| 1200 (AR) | | $500.00 | | 0.75 | ε375.00 | | AR |
| 4100 (Sales) | 101 | | $500.00 | 0.75 | | ε375.00 | Sales |
| 1200 (AR) | | $10.00 | | 0.75 | ε7.50 | | AR |
| 5101 (Fee) | 101 | | $10.00 | 0.75 | | ε7.50 | Fee |
| 5300 (Disc) | | $15.00 | | 0.75 | ε11.25 | | Disc |
| 1200 (AR) | 101 | | $15.00 | 0.75 | | ε11.25 | AR |

In Table 2 above, Dept refers to department, Trx refers to transaction, DR refers to debit, CR refers to credit, Exch refers to exchange, Func refers to functional, DT refers to distribution type, AR refers to accounts receivable and Disc refers to discount. In Table 2, the first and second columns include account numbers and department codes, respectively, which are defaulted by a default account system, for example, which is not represented in this document. The third through seventh columns of Table 2 include information that was either taken directly, or computed based on, information entered in screen 300. The eighth column of Table 2 includes distribution types linked with the respective distribution lines. As mentioned earlier, the distribution type linked to a distribution line dictates what actions can be performed on the distribution line. For example, if a user would like to split the distribution lines for the Disc distribution types (which means that the user wants the $15.00 discount to go to more than one account/dimension), the user would be prohibited from doing this because the attribute table does not allow the user to split distribution lines on the Disc distribution type.

It should be noted that, although the invoice example shown in FIG. 3 includes multiple currencies (a transaction currency (US$) and a functional currency (EURO)), the invention is not tied to currency conversion. Thus, even if the invoice example of FIG. 3 did not include multiple currencies, the utilization of distribution types to build distribution lines, and the assignment of distribution types to the created distribution lines, in accordance with the present invention would remain unchanged. Table 3 (which is essentially Table 2 without the Exch, Func DR and Func CR columns) below illustrates distribution lines created for the same invoice example with only a single currency involved.

TABLE 3

| Account | Dept | DR | CR | DT |
|---|---|---|---|---|
| 1200 (AR) | | $500.00 | | AR |
| 4100 (Sales) | 101 | | $500.00 | Sales |
| 1200 (AR) | | $10.00 | | AR |
| 5101 (Fee) | 101 | | $10.00 | Fee |
| 5300 (Disc) | | $15.00 | | Disc |
| 1200 (AR) | 101 | | $15.00 | AR |

In general, distribution types can be used to define attributes for any type of distribution line in any account module (accounts receivable, accounts payable, inventory, tax, etc.), without departing from the scope and spirit of the present invention.

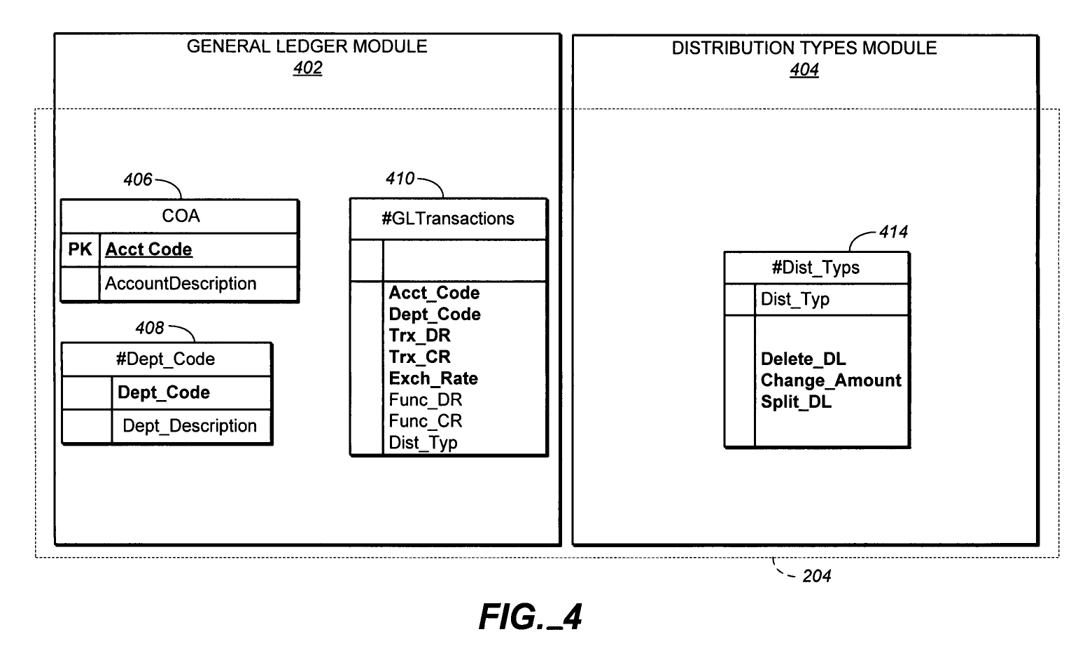

As mentioned above, transaction information or transaction records, such as those shown in Tables 1 and 2 above, are stored in a financial system database (such as 204), which typically includes multiple tables for each accounting module. FIG. 4 is a simplified block diagram illustrating account modules with different tables. Account information, dimension information such as department codes, and distribution lines (such as those shown in Table 2) can be stored in tables (included in database 204) that form a part of a general ledger (GL) module 402 shown in FIG. 4. For example, account numbers are stored in an Acct_Code field of a chart of accounts (COA) table 406. The Acct_Code is a primary key (PK) in COA table 406, which also includes an account description field. Department codes and the corresponding department descriptions are stored in a department code (Dept_Code) table 408. The distribution lines shown in Table 2 above are stored in a GL transactions table 410. Module 404 can include a distribution types (Dist_Typs) table 414 that includes a Dist_Typ field and fields for different distribution characteristics. Table 414 stores the information included in Table 1 above. Modules (such as 402 and 404) are fully integrated and share common data. Also, the earlier-described distribution type component 208, which includes software programs and functions, accesses the tables shown in FIG. 4 to assign attributes to distribution lines in accordance with the present invention.

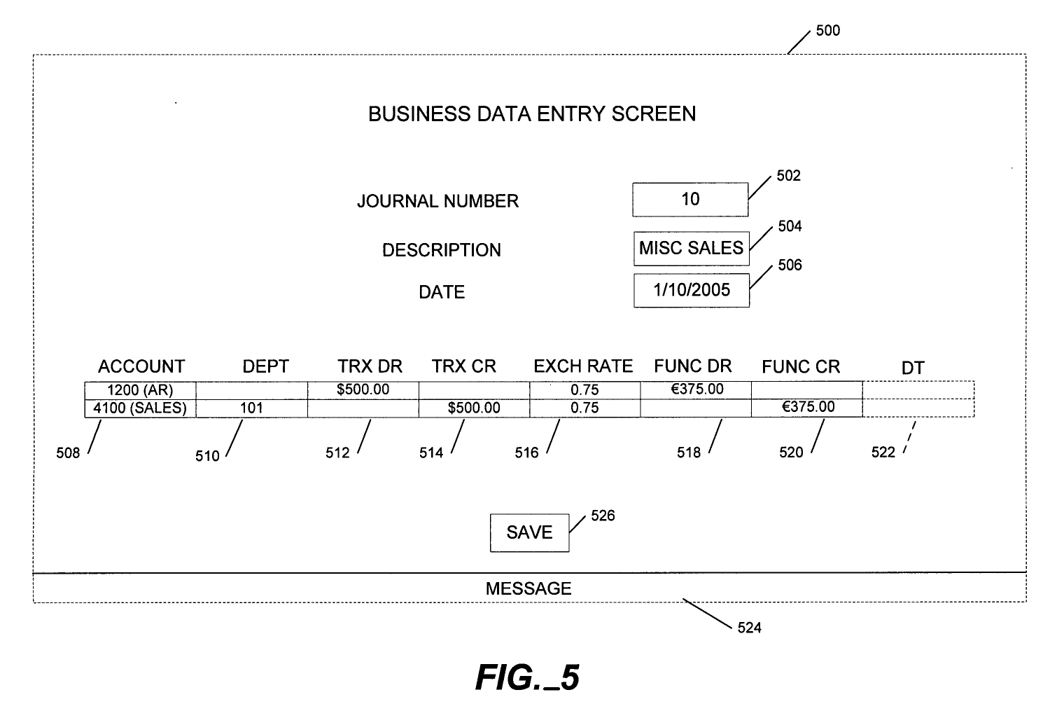

FIG. 5 is a simplified block diagram of an example business data entry screen 500, of the present invention, which illustrates how distribution types can be utilized without being associated with, or tied to, an amount. As can be seen in FIG. 5, a first portion of screen 500 includes a journal number field 502, a description field 504 and a date field 506. The second portion of screen 500, which includes columns 508-520, is used for entering debit and credit distribution lines. Screen 500 also includes a message line 524 and a save button 526. For simplification, the data included in columns 508-520 of screen 500 is essentially the same as the data shown in the first and second rows of Table 2 above. In screen 500, distribution types (DTs) 522, assigned to each distribution line, are not associated with amounts in the distribution lines. DTs 522 may sometimes be displayed to the user and may include a default general ledger (GL) distribution type, for example, which, in some embodiments, can be changed by the user. Thus, in accordance with the present invention, distribution types can be dependent or independent of transaction amounts.

Although the present invention has been described with reference to particular embodiments, workers skilled in the art will recognize that changes may be made in form and detail without departing from the spirit and scope of the invention. It should be noted that, in the above-described embodiments, only user interfaces are shown for entering transaction data. However, in accordance with the present invention, distribution types can be assigned to transaction data that is imported or created through a process, without human invention. Therefore, any suitable interface can be utilized for accepting transaction information, without departing from the scope and spirit of the invention.

What is claimed is:

1. A computer implemented method of managing business transactions, comprising:
providing an interface for accepting transaction header data, the transaction header data including a transaction header amount;
associating the transaction header amount with at least one distribution type of a plurality of distribution types; and
utilizing the at least one distribution type associated with the transaction header amount to build at least one transaction distribution line corresponding to the transaction header amount.

2. The method of claim 1 wherein the interface for accepting data is a user interface for entering transaction header data.

3. The method of claim 1 wherein utilizing the at least one distribution type to build at least one transaction distribution line comprises linking the at least one distribution type to the at least one transaction distribution line.

4. The method of claim 3 wherein the at least one distribution type linked to the at least one transaction distribution line defines at least one attribute of the at least one transaction distribution line.

5. The method of claim 4 wherein the at least one attribute dictates whether or not the at least one transaction distribution line can be split into multiple distribution lines.

6. The method of claim 4 wherein the at least one attribute dictates whether or not the at least one transaction distribution line can be deleted.

7. The method of claim 4 wherein the at least one attribute dictates whether or not an amount in the at least one transaction distribution line can be modified.

8. The method of claim 1 wherein the distribution types are transparent to a user entering transaction header data.

9. The method of claim 1 further comprising storing the at least one transaction distribution line in a financial system database.

10. The method of claim 9 wherein the at least one transaction distribution line is stored in a financial system database table that is a part of a general ledger module.

11. A computer system comprising:
a financial system comprising:
an interface for accepting transaction header data, the transaction header data including a transaction header amount; and
a distribution type component adapted to associate the transaction header amount with at least one distribution type of a plurality of distribution types,
wherein the distribution type component is further adapted to utilize the at least one distribution type associated with the transaction header amount to build at least one transaction distribution line corresponding to the transaction header amount.

12. The apparatus of claim 11 wherein the interface for accepting data is a user interface for entering transaction header data.

13. The apparatus of claim 11 wherein the distribution type component is adapted to utilize the at least one distribution type to build the at least one transaction distribution line by linking the at least one distribution type to the at least one transaction distribution line.

14. The apparatus of claim 13 wherein the at least one distribution type linked to the at least one transaction distribution line defines at least one attribute of the at least one transaction distribution line.

15. The apparatus of claim 11 wherein at least some of the plurality of distribution types are predefined in the financial system.

16. The apparatus of claim 11 wherein the financial system is configured to allow independent software vendors to define new distribution types.

17. The apparatus of claim 11 wherein the distribution types are transparent to a user entering transaction header data.

18. The apparatus of claim 11 further comprising storing the at least one transaction distribution line in a financial system database.

19. The apparatus of claim 18 wherein the at least one transaction distribution line is stored in a financial system database table that is a part of a general ledger module.

20. A computer system comprising:
a financial system comprising:
an interface for accepting business data; and
a distribution type component adapted to associate the business data with at least one distribution type of a plurality of distribution types,
wherein the distribution type component is further adapted to utilize the at least one distribution type associated with the business data to build at least one distribution line corresponding to the business data.
